(19) United States
(12) Patent Application Publication
(10) Pub. No.: US 2011/0153562 A1
(43) Pub. Date: Jun. 23, 2011

(54) ERROR PREVENTION FOR DATA REPLICATION

(76) Inventors: Gary Howard, Hertfordshire (GB); Simon Mark Irving, Oxfordshire (GB); Anthony Mervyn Sceales, London (GB); Alexis François Marie Sauvage, London (GB); Darren Michael Launders, Suffolk (GB)

(21) Appl. No.: 12/644,823

(22) Filed: Dec. 22, 2009

(51) Int. Cl. G06F 17/30

(52) U.S. Cl. 707/620; 707/E17.006

(57) ABSTRACT

A method and system for preventing error during data replication is provided. A replication entity model is used to represent data in a source and data in a target. One or more of a logical model, a directed relationship model or a state model may be provided to prevent error. The method and system may be applied to data migration and data synchronisation. The system comprises a transformation engine and a replication engine, wherein the replication engine is adapted to instruct the transformation engine to replicate each replication entity in turn. This may be based on the order dictated by the one or more directed relationships in the directed relationship model. Replication of a replication entity by the transformation engine comprises replicating data within one or more selected data structures of the source in one or more selected data structures of the target, the selection being based on the mapping between the replication entity model data in the source and data in the target.

### FIELD OF THE INVENTION

The present invention is in the field of data replication, in particular data replication during data migration. The invention comprises a computer-implemented method and a system for preventing errors during data replication by ensuring that data is replicated in a required order. The invention may also be used in the field of data synchronisation.

### DESCRIPTION OF THE RELATED ART

Data migration typically involves replicating, in a second database, data originally stored in a first database, wherein the two databases are of different design. In the art there is often the need to migrate data from one system to another. For example, a user may have an out-of-date or legacy system which they wish to upgrade; may wish to make their data available to a new application; or may need to assimilate their existing data into a third party system due to a merger or organisational transfer.

To achieve this migration, data is typically exported from an existing or source system and loaded into a new or target system. There are a number of methods for exporting data from, and loading data into, a data-based or database system. These include exporting and loading a complete database, exporting selected data and loading it directly into database tables, and exporting and loading data via procedure calls defined by database management software. While these methods are suitable for basic database structures, modern computer systems typically add additional layers of complexity which complicates the process.

For example, many system providers “hide” the underlying data from a user, typically by providing an application through which a user accesses and manipulates the data. These applications use proprietary methods to store and access the underlying data and so any request to export or load data must be made using an application interface (API).

When exporting or loading data, all of the methods discussed above require that a particular set of commands are processed in a particular order to maintain the integrity of the underlying data or database. For example, the application may require a strictly defined sequence of interactions with the application interface. This then means that each data migration process is a bespoke affair, requiring a large number of scripted processes to be manually coded by technical personnel with knowledge of both the source and target systems. As each data migration process typically involves different source and target systems, the coding of these scripted processes needs to be repeated in a different way for each migration operation. It also means that the data migration process is prone to error; mistakes in the scripted processes, omissions and incorrect ordering all contribute to a risk of ‘fall out’ or ‘errors’ in an export or load process. This means that a lot of time, effort, and hence cost, is spent rectifying these ‘errors’ during the migration process.

WO 2004/036344 A2 discloses a system and method for the optimisation of database access in database networks. One embodiment of this system and method presents an automatic migration monitor that logs communication between source and target systems during a migration operation. However, this embodiment is still based on a scripted process and so suffers from the drawbacks set out above.

Habela P. et al's publication “Overcoming the Complexity of Object-Oriented DBMS Metadata Management” (OOIS, International Conference on Object Oriented Information Systems—XP002401007) discusses the merits and disadvantages of a number of object-oriented database management schemes. They suggest the use of a flat metadata structure to reduce modelling complexity. However, their suggestions are limited to the design realm and offer no solutions for the problems of data migration.

WO 2007/045860 A1 discloses a system and method for accessing data stored in one or more databases. This publication suggests a model, a meta-model and a rule-based processing scheme. One embodiment describes the use of the meta-model and rule-based processing scheme to facilitate data migration. However, this embodiment provides no teaching that could help reduce errors during the data migration process.

There is thus a need in the art for a system and/or method of data replication, for use in data migration, which alleviates at least one or more of the problems discussed above.

### SUMMARY OF THE INVENTION

According to a first aspect of the present invention, there is provided a method for replicating data between a source and a target, comprising:

defining a physical model of data stored within the source and a physical model of data stored within the target, each physical model representing a plurality of data structures;

defining a logical model of the data of the source and a logical model of the data of the target, each logical model comprising a plurality of nodes and being based on the data structures of the corresponding physical models;

defining a replication entity model comprising a plurality of replication entities, wherein each replication entity represents a corresponding logical node from each of the logical models;

defining one or more directed relationships between the replication entities defined in the replication entity model, the one or more directed relationships being specified by the data methods of the target; and

based on the order dictated by the one or more directed relationships, instructing the replication of each replication entity in turn,

wherein replication of a replication entity comprises replicating data within one or more selected data structures of the source in one or more selected data structures of the target, the selection being based on the mapping between the replication entity model and each of the logical models and the mapping between each of the logical models and the respective physical model.

According to a second aspect of the present invention, there is provided a system for data replication between a source and a target, comprising:

a transformation engine connectable to the source and the target, the transformation engine comprising:

a physical model of data stored within the source and a physical model of data stored within the target, each physical model representing a plurality of data structures; and

a logical model of the data of the source and a logical model of the data of the target, each logical model comprising a plurality of nodes and being based on the data structures of the corresponding physical models; and

a replication engine connectable to the transformation engine, comprising:

a replication entity model comprising a plurality of replication entities, wherein each entity represents a corresponding logical node from each of the logical models; and

a directed relationship model comprising one or more directed relationships between the replication entities defined in the replication entity model, the one or more directed relationships being specified by the data methods of the target;

wherein, in use, the replication engine is adapted to instruct the transformation engine to replicate each replication entity in turn based on the order dictated by the one or more directed relationships in the directed relationship model, and

wherein replication of a replication entity by the transformation engine comprises replicating data within one or more selected data structures of the source in one or more selected data structures of the target, the selection being based on the mapping between the replication entity model and each of the logical models and the mapping between each of the logical models and the respective physical model.

According to a third aspect of the present invention, there is provided a method for replicating data between a source and a target, comprising:

defining a replication entity model comprising a plurality of replication entities, wherein each replication entity represents data stored in the source and data stored in the target;

generating a dependency graph comprising one or more directed relationships between the replication entities defined in the replication entity model, the one or more directed relationships being specified by the data methods of the target; and

based on the order dictated by the one or more directed relationships, instructing the replication of each replication entity in turn,

wherein replication of a replication entity comprises replicating data within one or more selected data structures of the source in one or more selected data structures of the target.

According to a fourth aspect of the present invention, there is provided a system for data replication between a source and a target, comprising:

a transformation engine connectable to the source and the target; and

a replication engine connectable to the transformation engine, comprising:
a replication entity model comprising a plurality of replication entities, wherein each entity represents data stored in the source and data stored in the target; and
a dependency graph comprising one or more directed relationships between the replication entities defined in the replication entity model, the one or more directed relationships being specified by the data methods of the target;

wherein, in use, the replication engine is adapted to instruct the transformation engine to replicate each replication entity in turn based on the order dictated by the one or more directed relationships in the dependency graph, and

wherein replication of a replication entity by the transformation engine comprises replicating data within one or more selected data structures of the source in one or more selected data structures of the target.

According to a fifth aspect of the present invention, there is provided a method for replicating data between a source and a target, comprising:

defining a replication entity model comprising a plurality of replication entities, wherein each replication entity represents data stored in the source and data stored in the target;

generating a state model for one or more instances associated with each replication entity defined in the replication entity model; and

using the state model, instructing the replication of the one or more instances associated with each replication entity in turn,

wherein replication of an instance of a replication entity comprises replicating data within one or more selected data structures of the source in one or more selected data structures of the target.

According to a sixth aspect of the present invention, there is provided a system for data replication between a source and a target, comprising:

a transformation engine connectable to the source and the target; and

a replication engine connectable to the transformation engine, comprising:
a replication entity model comprising a plurality of replication entities, wherein each entity represents data stored in the source and data stored in the target; and
a state model for one or more instances associated with each replication entity defined in the replication entity model;

wherein, in use, the replication engine is adapted to use the state model to instruct the transformation engine to replicate the one or more instances associated with each replication entity in turn, and

wherein replication of an instance of a replication entity by the transformation engine comprises replicating data within one or more selected data structures of the source in one or more selected data structures of the target.

Exemplary embodiments of the present invention combine a number of capabilities to eliminate errors resulting from data replication. This is achieved, for example, by enforcing the natural order of data during the activity of loading data into a target or destination system, and by ensuring that successor data instances of a replication entity are not attempted to be replicated if any required predecessor instances of the replication entity have failed to replicate successfully.

The “natural order” of data is the name given to the sequence of data operations that must be adhered to when replicating or migrating data between systems. The natural order must be maintained in order that exceptions or errors do not occur on the destination system or interface. The constraints of the natural order determine the sequence in which data can be loaded.

The natural order is typically determined by the target system and its methods for processing data. Typically, this in turn is based on the relationships between the data structures stored within the target. It may also be based on the design of the application program interface (or interfaces) used by the target.

The method and system of the invention is particularly suited to data migration. However, the principles of data movement and transformation may also be applied to data synchronisation.

In a preferred embodiment, maintaining the natural order is achieved using a directed relationship model in the form of a dependency graph. There may be multiple graphs for different sets of replication entities. The directed relationship model allows a user to define the natural order of the target or destination system's data-load interface and then have this order enforced during migration. Error is reduced, in exemplary embodiments, by using a feature known as predecessor tracking. This ensures that migration of data is not attempted where required predecessor data objects has failed to migrate successfully.

### BRIEF DESCRIPTION OF THE FIGURES

Embodiments of the present invention will now be described and contrasted with known examples with reference to the accompanying drawings, in which:

FIG. 1 is a schematic illustration of an exemplary system for replicating data according to the present invention;

FIG. 2A shows a first exemplary logical model;

FIG. 2B shows a first exemplary dependency graph;

FIG. 3 shows data that conforms to the model of FIG. 2A;

FIG. 4 shows in more detail the components of a preferred system for replicating data according to the present invention;

FIG. 5A shows a first exemplary physical model for source data and FIG. 5B shows a second exemplary logical model based on said first physical model;

FIG. 6A shows a second exemplary physical model for target data and FIG. 6B shows a third exemplary logical model based on said second physical model;

FIG. 7A shows a number of replication entities and their corresponding logical nodes;

FIG. 7B shows a first exemplary dependency graph and FIG. 7C shows a second exemplary dependency;

FIG. 8A shows the modifications to the second exemplary logical model required for data replication;

FIG. 8B shows a realised dependency graph based on FIG. 7B;

FIG. 9 shows a number of preparatory steps for an exemplary data replication process;

FIG. 10 shows a number of run-time steps for the exemplary data replication process;

FIG. 11 shows an exemplary state model; and

FIG. 12 shows the system components that may be used to implement the present invention.

### DETAILED DESCRIPTION OF THE EMBODIMENTS

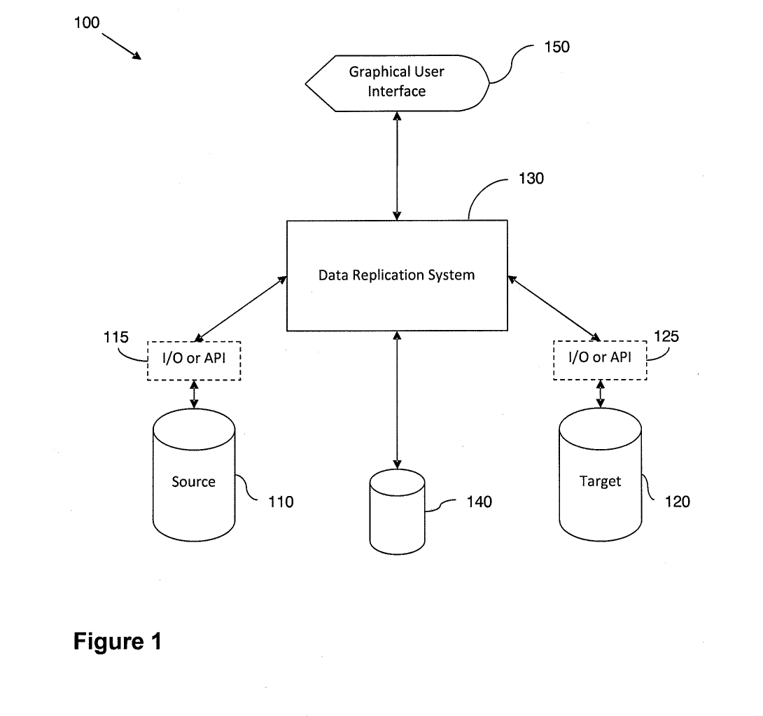

FIG. 1 shows an exemplary data replication system 130. The data replication system 130 is couplable to a source 110 and a target 120. The source 110 and target 120 may comprise one or more databases or other data storage systems. The data replication system 130 may also optionally be adapted to process a source 110 and/or target 120 comprising flat files. The source 110 and/or the target 120 are preferably accessed through respective input/output (I/O) interfaces 115 and 125. These interfaces 115 and 125 may comprise one or more application interfaces (API) that allow access to data stored within an application. These interfaces may comprise any mixture of Structure Query Language (SQL), Open Database Connectivity (ODBC), Java Database Connectivity (JDBC) or proprietary interfaces. The interfaces may be implemented using any known programming language, including but not limited to, Java, C++, and .Net. In certain embodiments, for example when using flat files, there may be a mapping to SQL to implement an interface. The configuration of the source 110 and target 120, and their respective interfaces 115 and 125, will differ depending on the circumstances of implementation; the present invention provides a solution that is configured to mitigate these differences.

The data replication system 130 is also preferably couplable to a control database 140 and a graphical user interface (GUI) 150. The control database 140 may be configured to provide an external store for control data associated with the replication process; alternatively, such control data may be stored as part of the data replication system 130. The GUI 150 facilitates management of the data replication system 130 and allows a user to create, modify and delete control and configuration settings. The GUI 150 may be provided on a local display or may be rendered on a remote device such as a portable computing or communications device, wherein the remote device is configured to receive data to instantiate the GUI from the data replication system 130 over a network (not shown).

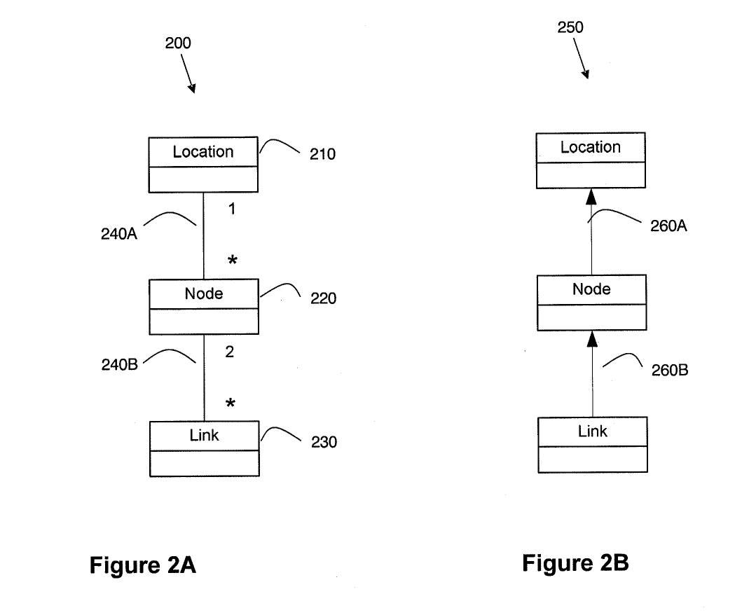

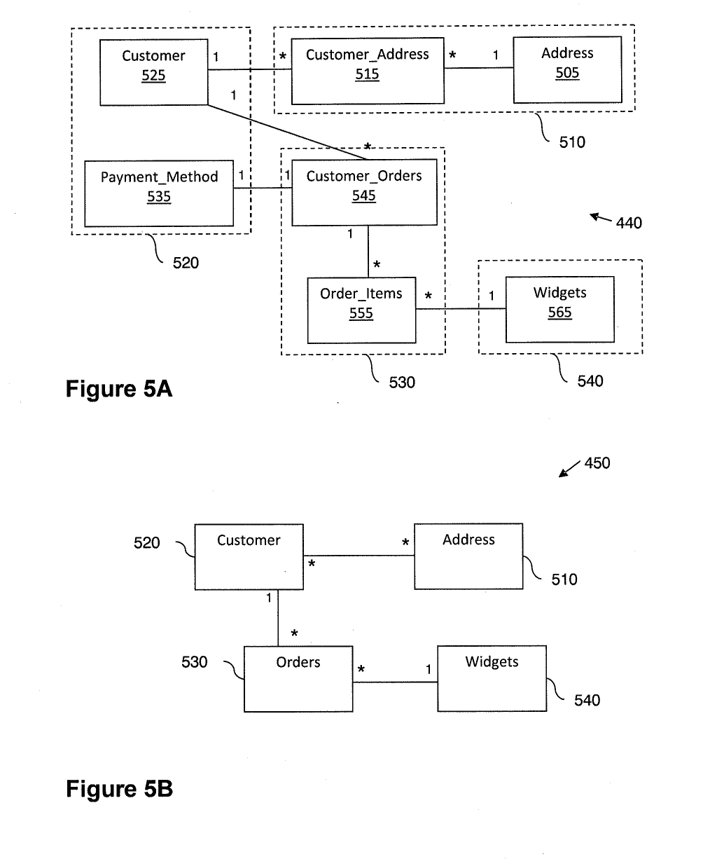

FIG. 2A shows an exemplary logical data model 200 for part of a network inventory belonging to a telecoms operator. The data this logical data model represents may be stored in the source 110 or target 120. The simple, well-behaved example of FIGS. 2A and 2B has been chosen to aid explanation of the basic concepts underlying the invention and for comparison with the examples of FIGS. 5A,B and 6A,B. In most real-world implementations the models will be more complex.

The logical data model 200 has three logical views: “Location” 210, “Node” 220, and “Link” 230. Each logical view may represent one or more data structures at a physical level, wherein the data structures may comprise data tables. Instances of each logical view may exist independently of the one or more data structures at a physical level and in certain embodiments a logical view may be manipulated in the same manner as a data table, wherein each instance of the logical view forms a record of said table. A logical view may be defined using SQL commands. The associations between logical views are represented by relationships 240A and 240B. These relationships represent relationships between one or more physical data tables at a logical level. For example, relationship 240A stipulates that logical view “Location” 210 has a one-to-many relationship with logical view “Node” 220. This may be represented at a physical level by a foreign key relationship, i.e. a “Node” record in a “Node” table may require a single “Location” record foreign key, wherein the same “Location” record foreign key may be present in other “Node” records. Likewise, relationship 240B stipulates that logical view “Node” 220 has a two-to-many relationship with logical view “Link” 230.

FIG. 2B provides a graphical representation of a dependency graph 250 produced based on the logical data model 200 of FIG. 2A. The dependency graph 250 is a form of directed relationship model and represents the order in which the logical groups 210, 220 and 230 must be processed to prevent error. The dependency graph consists of an acyclic directed graph of nodes. Each node of the graph represents a logical view. In a data migration example, the dependency graph determines the sequence in which the logical views, and by extension the physical data records that map onto said logical views, are migrated. In FIG. 2B logical view “Link” 230 depends on logical view “Node” 220, and logical view “Node” 220 depends on logical view “Location” 210. Hence, the order in which objects must be processed is: logical view “Location” 210, logical view “Node” 220, and then logical view “Link” 230.

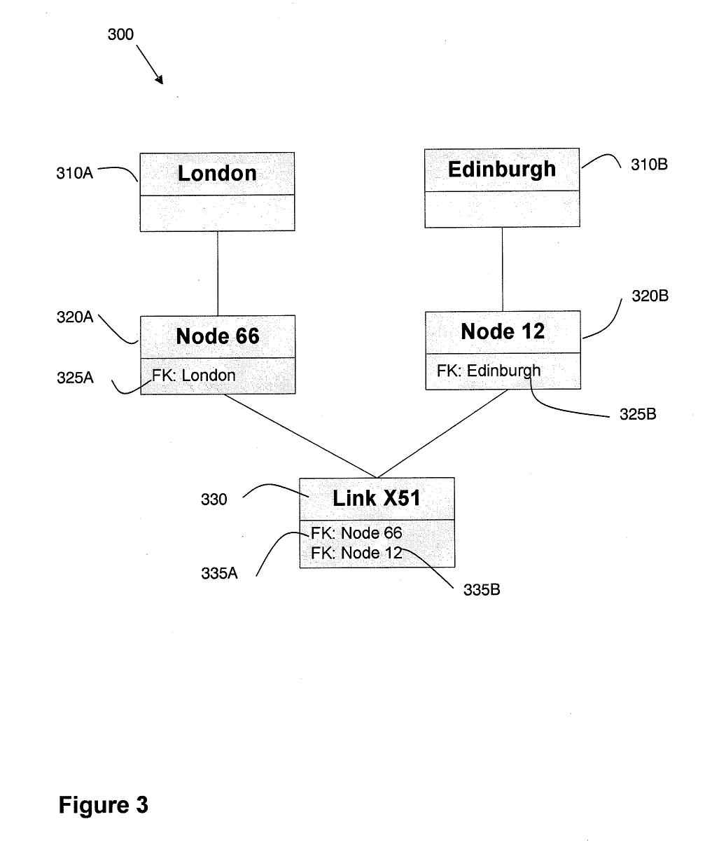

FIG. 3 shows an example of a number of data records 300 that represent data upon which the relationships of FIGS. 2A and 2B are based. “London” 310A and “Edinburgh” 310B are data records within a table that is represented by logical view “Location” 210. “Node 66” 320A is a data record within a table that is represented by logical view “Node” 220. Data record “Node 66” 320A has a foreign key 325A field that stores the primary key of data record “London” 310A. This foreign key relationship is represented by logical relationship 240A and the dependency is represented by relationship 260A. Likewise, data record “Node 12” 320B has a foreign key 325B field that stores the primary key of data record “Edinburgh” 310B. This foreign key relationship is also represented by logical relationship 240A and the dependency is also represented by relationship 260A. Finally, “Link X51” 330 is a data record within a table that is represented by logical view “Link” 230. Data record “Link X51” 330 has two foreign keys 335A and 335B; respectively storing the primary key values of data records “Node 66” 320A and “Node 12” 320B. These foreign keys provide a foreign key relationship that is represented by logical relationship 240B and a dependency that is represented by relationship 260B. As FIGS. 2A and 2B show limited examples of relationships, it is understood that the cardinality of other relationships, such as many-to-many, may be more complex.

The present invention makes use of logical data models and dependency graphs to successfully replicate data. The replication of data may involve the transfer of data stored in the source 110 to the target 120 or the transfer of data stored in the target 120 to the source 110. For ease of explanation, a data migration context will be used that uses the former data transfer. The data to be replicated may comprise all of the data in the source 110 and/or target 120 or a subset of such data. Likewise, the logical data models and dependency graphs may represent all of the data in the source 110 and/or target 120 or a subset of such data.

The present invention further uses a replication entity model to link logical views in a source logical data model to logical views in a target logical data model. In the following discussion logical views will be referred to as nodes in the logical model. Preferably, each replication entity in the replication entity model provides a one-to-one mapping between a node in the source logical data model and a node in the target logical data model. As above, the replication entity model may represent all of the data in the source 110 and/or target 120 or a subset of such data.

Nodes in the logical data models, may be chosen to represent real-world entities or groupings which may not exist at the physical data level (i.e. the level at which data is physically stored in data structures such as tables in the databases of the source 110 and/or target 120). For example, in a business context an organisation may comprise offices, employees and manufactured products; hence, a logical data model may be defined with nodes respectively representing offices, employees and manufactured products. A replication entity would then represent a corresponding node. Each node may represent a view of particular data, typically in the form of one or more data records in one or more data tables; for instance, in the business context example, heterogeneous data for each employee may be stored across multiple linked tables in the source 110 but the data for all employees may be represented by a single “Employee” node, wherein the data for a particular employee is referred to as an “instance” of the node. A further “Staff” replication entity may then also be used represent the “Employee” logical node.

In most cases, the data of the source 110 will have a different format from the data of the target 120; e.g. the data of the target 120 may comprise different data structures and/or foreign key relationships at the physical data level. The source 110 and target 120 may have different methods for accessing data which may produce a difference in data format. In embodiments involving applications lacking clearly visible data structures and/or object-oriented databases associations between data may be represented without using foreign key relationships, for example using linking mechanisms at the program level. In a typical database embodiment, the data of the target 120 may also comprise differing field and table names. A combination of one or more of these factors leads to differences in the logical data models for both the source 110 and target 120. The replication entity model then provides a mapping from one node in the source logical data model to a corresponding node in the target logical data model.

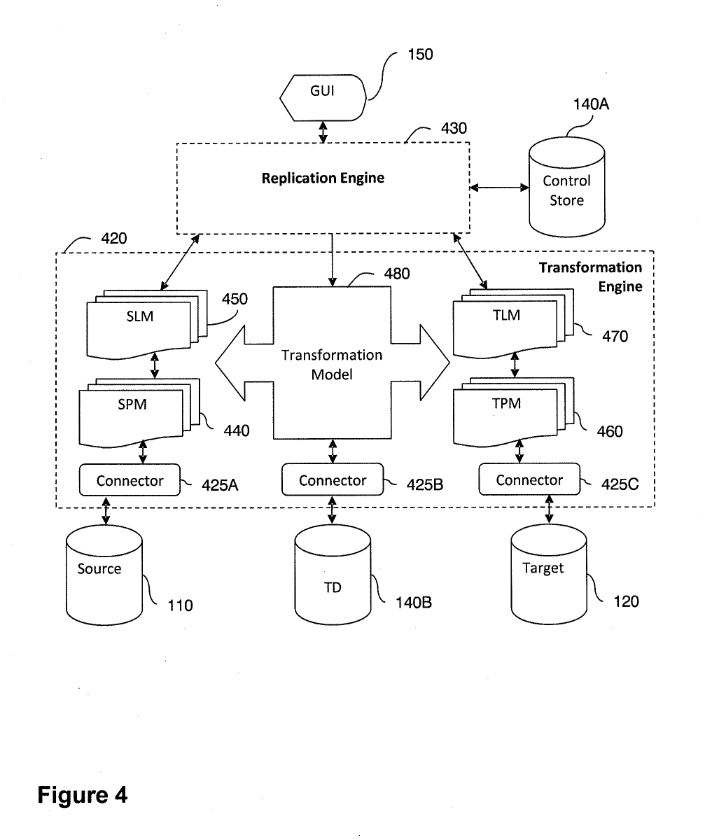

The use of the logical and replication entity models will now be described with reference to a preferred embodiment of the data replication system 130 as shown in FIG. 4. Common features from FIG. 1 are labelled as such.

Data replication system 130 has two core components: transformation engine 420 and replication engine 430. Transformation engine 420 is couplable to source 110 and target 120. Coupling is provided by connectors 425A and 425C which may comprise interfaces 115 and 125 plus any necessary logic to access data within source 110 and target 120; for example connectors 410 may comprise one or more of ODBC and JDBC drivers. Transformation engine 420 is further optionally couplable to transitional database 140B via connector 425B. Transitional database 140B stores data for use in data replication and/or transformation. The data stored in transitional database 140B may comprise additional information that needs to be injected by transformation engine 420 during data transformation; for example, the target 120 may require information for a field that is not present in the source data. The transitional database 140B may also store data used for data type mapping(s).

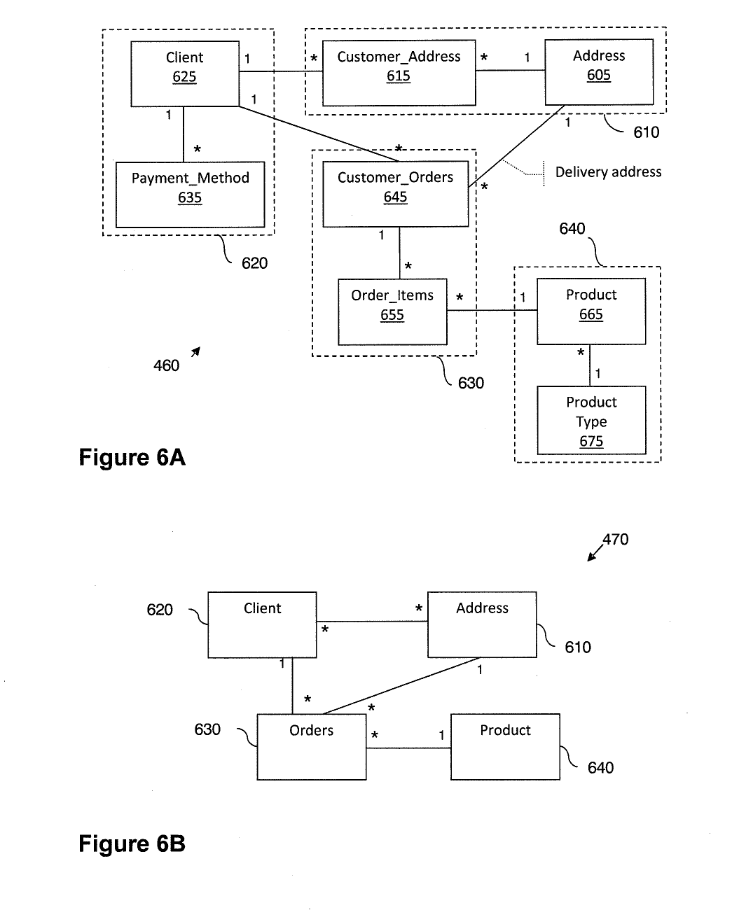

Transformation engine 420 is adapted to access a source physical model 440 and a target physical model 460. The physical models may be stored as part of the transformation engine 420 or in a separate storage device. Source physical model (SPM) 440 comprises a model of all or part of the data within the source 110 at the physical data level, e.g. representing data structures such as data tables and the actual foreign key relationships between such tables or the manner in which the application or object-orientated database actually stores the data. In a similar manner, target physical model (TPM) 460 comprises a model of all or part of the data within the target 110 at the physical data level. An exemplary source physical model 440 is shown in FIG. 5A and an exemplary target physical model 460 is shown in FIG. 6A. In most cases, the physical models of the source and target are different. Each data structure of the physical model has zero or more instances: where the data structure comprises a data table these instances may be records of the table, where the data structure comprises a database object these instances may be instances of the object class and where the data structure comprises an element of an application these instances may be an embodiment of the element. Each instance has an associated identifier. For example, if the instance comprises a record the identifier may be a key field value (“physical key”) of the record; if the instance comprises a database object the identifier may be a unique string.

Transformation engine 420 is also adapted to access logical models of the source 450 and target 470. The logical models may also be stored as part of the transformation engine 420 or in a separate storage device. Source logical model 450 comprises a model of the source data set out in the physical model 440 at a logical level, e.g. representing logical views and relationships that may differ from the physical organisation as set out in the source physical model 440. Likewise, target logical model 470 comprises a model of the target data set out in the physical model 460 at a logical level, e.g. representing logical views and relationships that may differ from the physical organisation as set out in the target physical model 460. An exemplary source logical model 450 is shown in FIG. 5B and an exemplary target logical model 470 is shown in FIG. 6B.

Nodes in the logical models comprise a view of the data that may involve information from multiple tables or database objects. In certain implementations the view of data provided by a node could comprise different subsets of data from the same table or database object; for example a “Customer” table may have a “Referring Customer” field which contains a “Customer” key, the logical node “Referee” may comprise all the “Customers” whose keys are present in the “Referring Customer” field.

Each node in the logical model also has zero or more instances: where the view is represented by a data table, for example generated by a SQL command, each instance may be a record in the view data table. Each instance of a logical node also has an associated identifier. This may be, for example, a key field value (“logical key”). The logical key may be generated as a composite value based on physical keys or identifiers, for example a string concatenation of two physical keys, or as a new unique value. In certain embodiments, the present system may be adapted to access more than one source system and/or more than one target system. In this case, a logical node may comprise data from two or more distinct systems or databases.

Transformation engine 420 further comprises a transformation model 480 adapted to transform the data from the source 110 into a form readily acceptable by the target 120. The transformation model 420 contains all the necessary data mappings to provide the transformation. The transformation model 420 may make use of transitional database 140B.

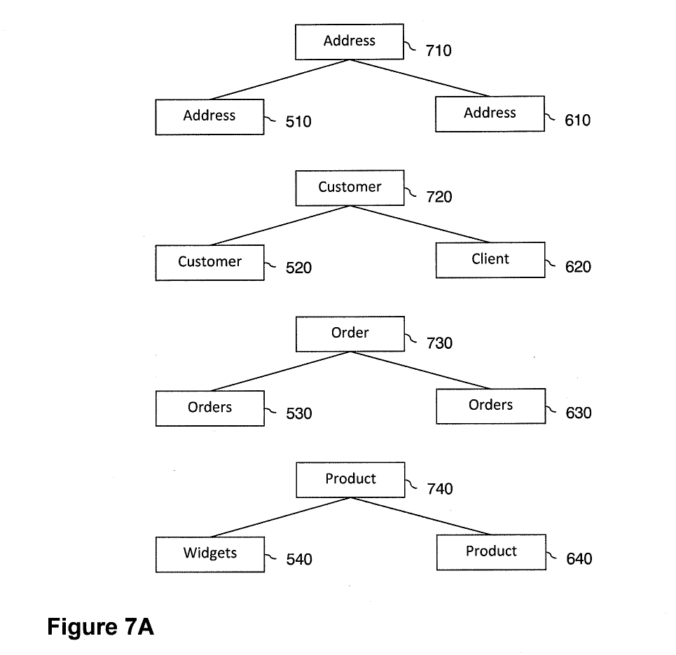

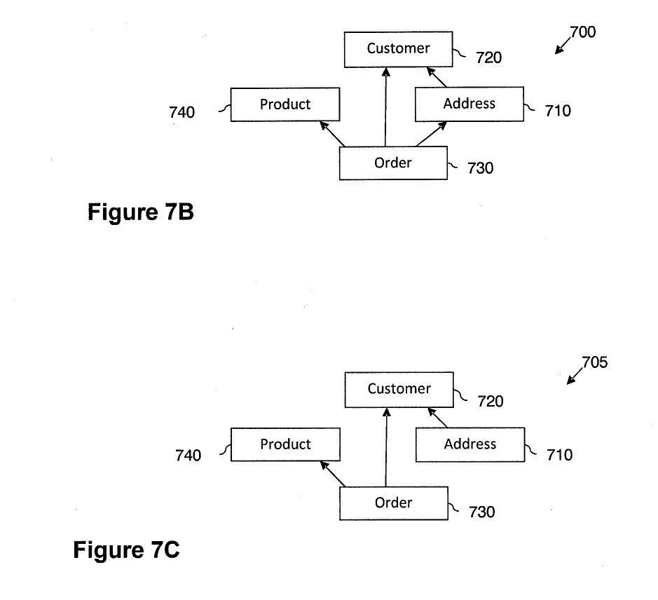

The transformation engine 420 is coupled, in use, to the replication engine 430. The replication engine 430 stores the replication entity definitions that comprise the replication entity model and the links to the relevant nodes of the source logical model 450 and the target logical model 470. It may optionally be connected to a control store 140A to store control data. Replication engine 430 controls transformation engine 420 during data replication and may optionally be coupled to GUI 150. As part of the replication entity model, the replication engine 430 may store database key mappings and state models as described below. The replication engine 430 also uses control data generated based on the interface dependencies of the target 120 and/or the source 110, depending on the replication direction(s). The interface dependencies determine the directed relationships of replication entities in a directed relationship model. A directed relationship model in the form of a dependency graph is shown, for the target 120, in FIG. 7B and, for the source 110, in FIG. 7C.

An example of a data migration process using the preferred embodiment of the data replication system 130 will now be described, wherein data in source 110 is to be replicated in target 120. In this example, source 110 and target 120 comprise different data systems with different data structures and different data organisation. The example sets out the steps involved in error prevention during a migration.

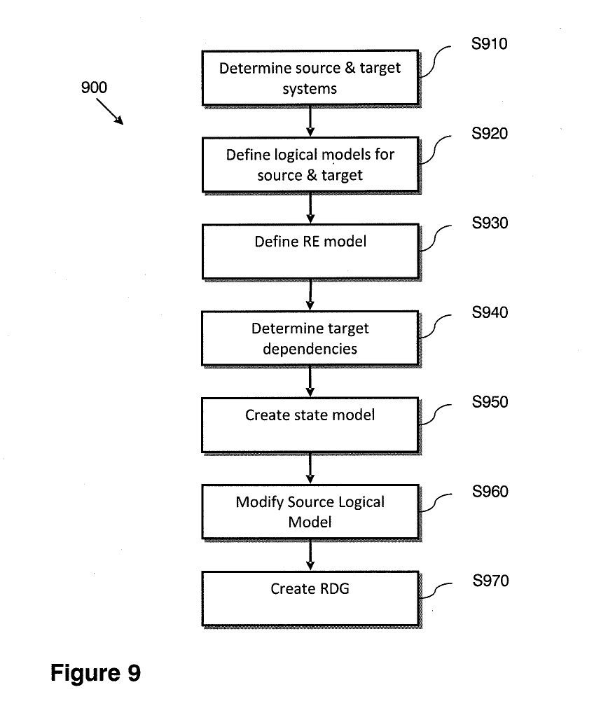

First, a number of preparatory steps are performed. These steps 900 are illustrated in FIG. 9. The steps are common to all data synchronisation and replication processes and are not restricted to a migration process.

At step S910, a determination of the source 110 and target 120 systems is made. This may involve gathering descriptive data for both the source 110 and target 120, such as their location, size, data organisation etc. From the descriptive data or otherwise, the source physical model 440 and the target physical model 460 are generated.

FIG. 5A shows the source physical model 440 for a particular subset of source data. FIG. 5A shows seven data tables together with the foreign key relationships between the tables. Address table 505 has a one-to-many relationship with Customer_Address table 515. Customer table 525 has a one-to-many relationship with both Customer_Address table 515 and Customer_Orders table 545. Customer_Orders table 545 has a one-to-one relationship with Payment_Method table 535 and a one-to-many relationship with Order_Items table 555. Finally, Widgets table 565 has a one-to-many relationship with Order_Items table 555.

FIG. 6A shows the target physical model 460 for the same data. As can be seen, there are several differences between the source and target physical models. FIG. 6A shows eight data tables together with the foreign key relationships between the tables. Address table 605 has a one-to-many relationship with Customer_Address table 615 and Customer_Orders table 645. Client table 625 has a one-to-many relationship with Customer_Address table 615, Payment_Method table 635 and Customer_Orders table 645. Customer_Orders table 645 has a one-to-many relationship with Order_Items table 655. Product table 665 has a one-to-many relationship with Order_Items table 655 and Product Type table 675 has a one-to-many relationship with Product table 665.

At step S920, corresponding logical models for both the source and the target are defined. As is shown in FIGS. 5A and 6A this may be achieved by producing logically views of the data tables. Logical view 510 in FIG. 5A forms logical node Address 510 in FIG. 5B; logical view 520 forms logical node Customer 520; logical view 530 forms logical node Orders 530; and logical view 540 forms logical node Widgets 540. Likewise, logical view 610 in FIG. 6A forms logical node Address 610 in FIG. 6B; logical view 620 forms logical node Client 620; logical view 630 forms logical node Orders 630; and logical grouping 640 forms logical node Product 640. The actual foreign key relationships at the physical level are also mapped to appropriate node relationships at the logical level.

After the logical models for both source and target have been defined a replication entity (RE) model is generated at step S930. The replication entities that make up the replication entity model are shown in FIG. 7A. In FIG. 7A there are four replication entities: Address 710, Customer 720, Order 730 and Product 740. Address replication entity 710 links Address node 510 in source logical model 450 with Address node 610 in target logical model 470; Customer replication entity 720 links Customer node 520 in source logical model 450 with Client node 620 in target logical model 470; Order replication entity 730 links Orders node 530 in source logical model 450 with Orders node 630 in target logical model 470; and Product replication entity 740 links Widgets node 540 in source logical model 450 with Product node 640 in target logical model 470.

At step S940, the target 120 is inspected in order to determine the system interface dependencies. In the present data migration example, the dependencies between replication entities are fixed by the target interface. Hence, the properties of the target interface need to be determined. For example, physical data structures corresponding to particular replication entities must be created and populated in the target 120 in a particular order to prevent error. In certain systems, the interface dependencies may depend on the particular programming language used, the manner in which a target application has been constructed and/or the manner in which database objects are related. As discussed previously, the interface may comprise one or more APIs. In a data synchronisation example, data from the target 120 may need to be replicated in the source 110; hence, the source 110 may also be inspected in a similar manner to the target 120 to determine the interface dependencies. There may also be multiple layers that represent each interface; for example an interface may require the sequence “Create(A); Create(B)” wherein this sequence is further broken down into the individual commands “Create(A1); Create(A2); Create(B1); Create (B2)”.

Using the system interface dependencies, a dependency graph is defined for the target 120. The dependency graph 700 demonstrates the directed relationships between the replication entities based on the data methods of the target and is illustrated in FIG. 7B. The data methods of the target are set by the system interface dependencies. As can be seen in FIG. 7, there is a dependency between Order and Address: this is required to accurately generate the “Delivery Address” physical relationship shown in FIG. 6A. The arrows on the graph 700 represent the direction of the dependency: for example, both Address replication entity 710 and Order replication entity 730 are dependent on Customer replication entity 720; Customer replication entity 720 must thus be migrated first. In a synchronisation example, a dependency graph may also be defined for the source 110 based on the source system interface dependencies. A dependency graph 705 between replication entities based on the source 110 is illustrated in FIG. 7C. The source dependency graph 705 does not feature the directed relationship between Order replication entity 730 and Address replication entity 710. Both forms of dependency graph may comprise a direct acyclic graph (DAG) and may be generated manually or automatically based on an inspection of the target 120 and/or source 110.

In a preferred embodiment, the system interface dependencies and models are generated using computer design tools. For example, any known Integrated Design Environment (IDE) may be used, making use of known plug-ins for the IDE as required. Preferably, the physical models 440/460, logical models 450/470, and the transformation model 480 are represented using the eXtensible Markup Language (XML) Metadata Interchange (XMI) standard and the dependency graph or graphs are represented using State Chart XML (SCXML). For example, the models and graphs may be stored as .xmi, .xml or .scxml files. However, any known or suitable standard in any programming language may alternatively be used as appropriate.

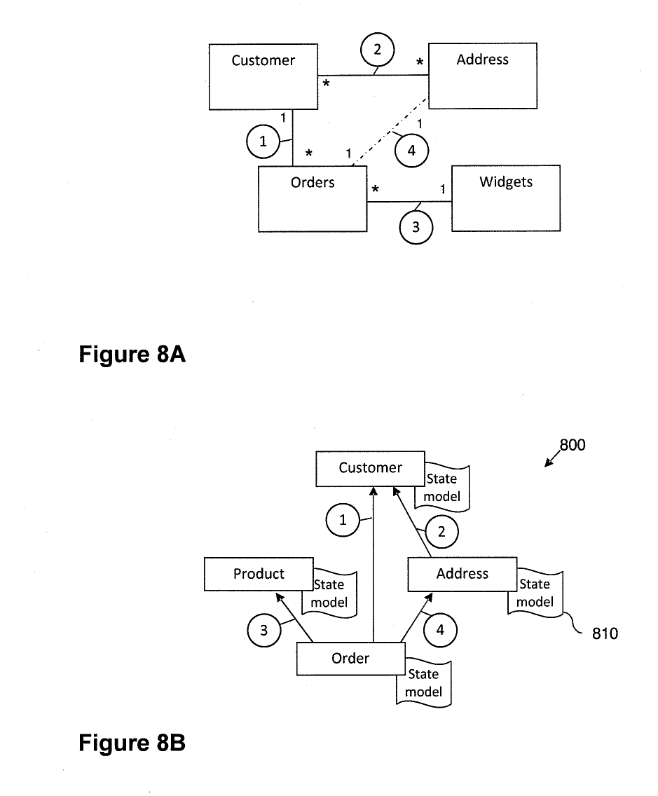

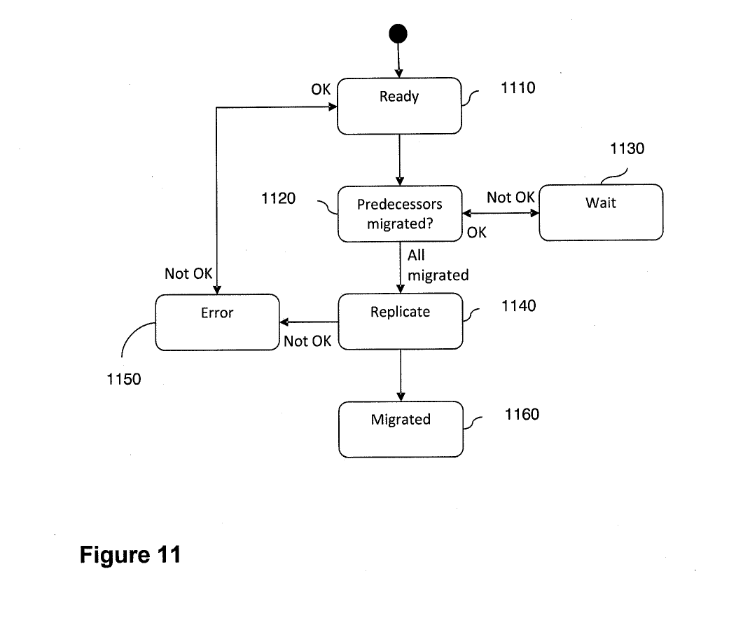

At step S950, there is the optional step of creating a state model for each replication entity. The state model comprises state information at the replication entity level and/or the logical instance level. For example, in the present data migration example, this may be whether a replication entity and/or its associated logical instances have been successfully migrated. In a synchronisation example, it may be whether and/or when a replication entity and/or its associated logical instances were synchronised. State models 810 are illustrated in FIG. 8B. A different state model may be provided for each direction of replication, e.g. in unidirectional synchronisation or migration there may only be a single state model but for bidirectional synchronisation there may be two state models, one for a synchronisation of data from source 110 to target 120 and one for a synchronisation of data from target 120 to source 110. The state model may be defined using XML. An example of a state model is provided in FIG. 11.

A replication entity is associated with a corresponding logical node in both the source logical model 450 and the target logical model 470. In use, depending on the direction, and possibly type, of replication the appropriate state model for a replication entity will be duplicated for each instance of the appropriate logical model node. For example, in use in a source-to-target migration, each instance of a node in the source logical model has a state model based on the source-to-target replication entity state model, wherein the node is selected based on the entity-node mapping for the source. In a target-to-source migration, each instance of a node in the target logical model has a state model based on the target-to-source replication entity state model, wherein the node is selected based on the entity-node mapping for the target.

At step S960 mapping information is generated to adapt the source logical model 450 to meet the target dependency requirements. In the present example, the target dependency requirements are represented by the dependency graph 700 of FIG. 7B. This requires modelling a new logical relationship between the Address node 510 and the Orders node 530, labelled as link 4 in FIG. 8A. The adaptation to the source logical model 450 may be realised by modifying the logical to physical layer mapping and as such may be represented by one or more mappings within the transformation model 480. In more complex examples, multiple modifications or enhancements to the logical source model 450 may be required.

Once the modification at step S960 has been performed the directed relationships in the target dependency graph 700 may be annotated with the source logical model relationships that map onto the dependencies to generate a realised dependency graph (RDG) at step S970. A realised source-to-target dependency graph 800 is shown in FIG. 8B. The realised dependency graph 800 of FIG. 8B also includes state model information 810 as generated in step S950. In cases involving replication in more than one direction more than one state model may be added to generate the realised dependency graph 800. The protocol used by the interface may also require more than one state model for each replication entity; for example an asynchronous target interface may require one state model whereas a synchronous target interface may require an alternative state model, this typically being because an asynchronous target interface would require more advanced “waiting” states.

The preparatory steps define the models that are required by the data replication system 130 for data migration or synchronisation. After the models have been created migration or synchronisation may take place.

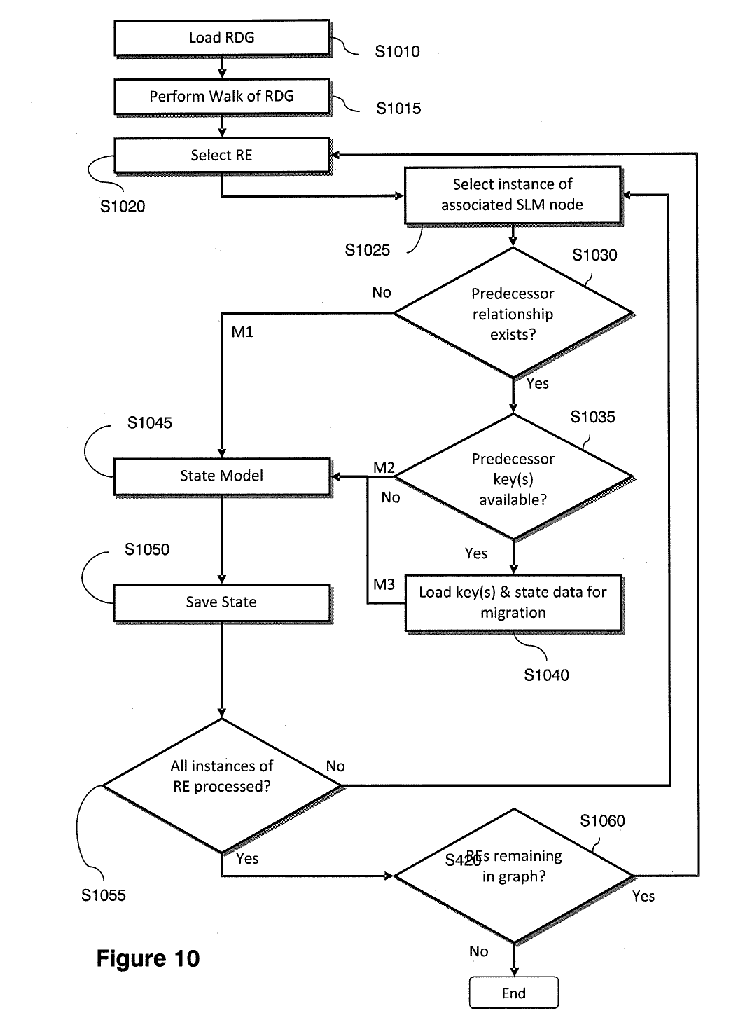

FIG. 10 shows the steps involved during a migration process. Typically, the steps of FIG. 10 are performed under the control of the replication engine 430. At step S1010, the realised dependency graph 800 is loaded and processed. The replication engine 430 determines the first replication entity to process as represented by the dependency graph 800 at step S1015. This is achieved using a breadth-first walk of the realised dependency graph 800. The walk of the graph 800 may be achieved by providing the graph 800 as input to any known algorithm implementing the walk, the algorithm being adapted to use data from the realised dependency graph 800 as input. Typically, such algorithms produce one or more lists that set out the dependency order of the replication entities for processing. Each list represents a valid dependency order.

At step S1020, the replication engine 430 analyses the result of the breadth-first walk to select the first replication entity for processing. The replication entity is used to determine an associated logical node of an appropriate logical model, for example using the mapping set out in FIG. 7A. For a source-to-target migration the appropriate logical model is the source logical model 450. At step S1025 a first instance of the associated logical node is selected. The instance has an associated identifier, for example a particular logical key. At step S1030 a determination is made as to whether any predecessor relationships types exist. This may be made by referring back to the realised dependency graph 800 or the output of the walk algorithm. If no predecessor relationships exist then the replication engine 430 runs the state model assigned to the selected instance at step S1045. Typically, the appropriate state for the instance is retrieved using the logical key of the instance. Alternatively, if the instance is being processed for the first time, the state of the instance may be initialised based on the state model. A message “M1” is also passed to the state model indicating that no predecessor relationships exist. The message may also contain the logical key of the instance.

If predecessor relationships exist then the appropriate logical key or keys of one or more predecessor instances (“predecessor keys”) are identified at step 1035. This may be achieved using the relationships of the appropriate logical model. For example, in a source-to-target migration the appropriate logical model is the source logical model 450. If the one or more predecessor keys are not available then the replication engine 430 runs the state model assigned to the selected instance at step S1045, passing message “M2” indicating no predecessor keys are available. Message “M2” may also comprise additional information relating to the selected instance and/or its predecessor instances. If one or more predecessor keys are available then at step S1040 the predecessor keys are used to retrieve state information for the predecessor instances. The state information may be in the form of a reference to the states of the one or more predecessor instances. These states may be stored as data for each instance based on the state model, wherein the state model comprises metadata for multiple instances. It may also comprise information setting out whether a particular predecessor is mandatory or optional. At step S1045, the replication engine 430 runs the state model assigned to the selected instance, passing message “M3” comprising the predecessor keys and state information retrieved at step S1040.

In certain embodiments, one or more of steps S1030, S1035 and S1040 may be incorporated into the state model and its execution. For example, steps S1035 and S1040 may be implemented as part of the “Predecessors Migrated?” state execution, wherein the predecessor keys and state information are retrieved for each predecessor instance when each predecessor instance is checked.

An exemplary state model is shown in FIG. 11. When each state model is assigned to an instance the state model is initialised. This may comprise setting the state model to the “Ready” state 1110. When the state model for each instance is run at step S1045 in FIG. 10 its current state is retrieved. The methods of the present state in the state model are then used, together with any message “Mx” and data passed to the state model, to perform the appropriate state transitions. For example, message “M2” may cause the state model to progress from “Ready” 1110 to “Error” 1150 whereas messages “M1” and “M3” may cause the state model to progress to “Predecessors Migrated?” 1120.

If the state information contained with message “M3” indicates all predecessor instances have been successfully migrated, e.g. are in a “Migrated” 1160 state, or allows this to be checked, then the state model may progress from “Predecessors Migrated?” 1120 to “Replicate” 1140. Likewise, if message “M1” indicates there are no predecessors the state model progresses directly from “Predecessors Migrated?” 1120 to “Replicate” 1140. If the state information contained with message “M3” indicates that one or more predecessor instances have not been successfully migrated, e.g. are not in a “Migrated” 1160 state, or allows this to be checked, then the state model may progress from “Predecessors Migrated?” 1120 to “Wait” 1130. The “Wait” state 1130 may be a time-limited state, in which case after a set time period the state model progresses back to “Predecessors Migrated?” 1120 and a further check of the predecessor instance states is made. Alternatively, an instance may be saved in a “Wait” state 1130 and a later user-triggered repeat of the migration process may resume the state model from the “Wait” state 1130. In this case an evaluation of the message “M3” may cause the resumed “Wait” state 1130 to progress to the “Predecessors Migrated?” state 1120.

When an instance is in the “Replicate” state 1140 the replication engine 430 instructs the replication of the selected instance. Replication comprises executing a call to the transformation engine 420. This may comprise providing the logical key of the current instance, information relating to the any predecessor instances and/or appropriate key mappings to the transformation engine 420. Based on the state of the state model appropriate transformation rules forming part of the transformation model 480 are selected. Replicating an instance, at a physical level, comprises the extraction of data from the source 110 and the loading of data into the target 120, typically using connectors 425A and 425C. This process may also comprise data transformation using transformation model 480 and transitional data 140B. The data that is extracted and loaded depends on the instance being replicated and the mappings between the logical models and the physical models as set out within the transformation engine 420. If there is an error during replication then this is indicated to the replication engine 430 by the transformation engine 420 and the state of the state model is set to “Error” 1150. Typically, the setting of a state is performed by replication controller 430. If replication is successful the state of the state model is set to “Migrated” 1160.

Returning to FIG. 10, at step S1050 the present state of the instance within the state model is saved. This may comprise persisting the state of the state model in control store 140A. At step S1055 a check is made to determine whether all instances associated with the appropriate logical node associated with the replication entity selected at step S1020 have been processed. If further instances remain then the method loops to step S1025 wherein the next instance is selected. Method steps S1025 to S1055 are repeated until all instances have been processed. At this point the method continues to step S1060, wherein a check is made as to whether further replication entities require processing. This may be achieved by checking the output of the walk algorithm. If further replication entities require processing the next replication entity in the specific order dictated by the realised dependency graph 800 is selected at step S1020. This may involve selecting the next replication entity in a list output by the walk algorithm. Steps S1020 to S1060 are then repeated, in order, for all remaining replication entities. Once all replication entities have been processed the method ends.

The method of FIG. 10 will now be applied to the data shown in FIGS. 5A to 8B for a source-to-target migration. The example will be described assuming that the source and target are databases, wherein the physical data structures are data tables and logical views are data tables produced using SQL commands, however, such features should not be construed as limiting and alternative source/target types and physical/logical representations may be used as appropriate. It will also be apparent to one skilled in the art that the migration method described herein can be adapted to provide data synchronisation.

First realised dependency graph 800 is loaded at step S1010. A breadth-first walk algorithm is applied to the realised dependency graph 800 at step S1015. The output of the algorithm is a list: “Customer, Product, Address, Order”. The algorithm may also produce other lists: “Customer, Address, Product, Order” and “Product, Customer, Address, Order” as the Product replication entity has no predecessor entity and so can be interchanged with the Customer and Address replication entities without causing error. If multiple lists are produced, one of the lists is selected for processing, in this case the first list is chosen.

Taking the first list, the first replication entity Customer 720 is selected. As the migration is source-to-target, the source logical node associated with the Customer replication entity 720 is retrieved. If data replication was occurring in the opposite direction, i.e. from target-to-source, the target logical node associated with the Customer replication entity 720 would be retrieved. In this case, using the mappings set out in FIG. 7A, the appropriate logical node is Customer 520 and the instances of this node comprise records of a data table that implements the node. At step S1025, the first instance, i.e. the first record, is selected and its logical key retrieved. At step S1030 the realised dependency graph 800 is examined and it is determined that no predecessor relationships exist. The state model of FIG. 11 is then run by replication engine 430 at step S1045. Message “M1” is passed to the state model.

Assuming that all instances associated with the Customer replication entity 720 have been initialised to “Ready” 1110, the state model progresses to “Predecessors Migrated?” 1120 and, as there are no predecessors indicated in message “M1”, “Replicate” 1140. When in the “Replicate” state 1140, replication engine 430 instructs the replication of the selected instance. The replication engine 430 passes information, typically the logical key of the instance, to transformation engine 420. The transformation engine 420 then uses the logical-to-physical mappings for each of the source and target models to respectively extract the appropriate data from the source 110, transform it if required, and load it into the target 120. In this example this involves extracting data from physical table Customer 525 and loading this data into physical table Client 625. It also involves similar operations, with transformation, on the Payment_Method tables 535 and 635. After replication the state of each instance is set to “Migrated” 1160 if migration has been successful. In a synchronisation example, state “Migrated” 1160 may be replaced with a “Synchronised” state. In certain embodiments two or more instances may be processed in parallel.

After running the state model, the current state for each instance is saved at step S1050. This may comprise storing data representative of the state in control store 140A, preferably together with key information. At step S1055, if more instances of logical node 520 remain, steps S1025 to S1055 are repeated for each remaining instance.

Control then proceeds to step S1060, wherein the list output by the walk algorithm is analysed and it is determined that the Product replication entity 740 is to be selected next. Assuming entity Product 740 is chosen, steps S1020 to S1060 are repeated as above for all instances of logical node Widgets 540.

At the next iteration of step S1060 it is determined that replication entity Address 710 needs to be processed. The method then loops to step S1020 wherein replication entity Address 710 is selected. At step S1025 logical node Address 510 is selected using the mapping shown in FIG. 7A and the instances, i.e. the records of the Address 510 view, are retrieved. The first instance is then selected. At step S1030, it is determined that a predecessor relationship exists: that with Customer 720. This determination is made using the realised dependency graph 800 or the output of the walk algorithm. At step S1035, a check is made to see if the required predecessor key for the predecessor instance of Customer 720 is available, wherein the predecessor instance comprises an instance of Customer view 520. This check may be performed using link 2 of the modified source logical model shown in FIG. 8A. In this example it is assumed the key is available and so at step S1040 the key is loaded for migration and the state data for the predecessor instance is retrieved. The state model is then run at step S1045 passing the information of step S1040 as message “M3”.

Turning to FIG. 11, it is assumed each instance of Address 510 is in the “Ready” state 1110. Based on message “M3” the state model progresses to state “Predecessors Migrated?” 1120. In this state the state of the predecessor instance is checked, typically using the predecessor key as an index. As all instances associated with replication entity Customer 720 were successfully replicated in the previous iteration of steps S1025 to S1060, the state of each predecessor instance is “Migrated” 1160. Thus, the state model for the present Address instance progresses to state “Replicate” 1140 and, if replication is successful, state “Migrated” 1160. At step S1050 the step of the present instance is saved and at step S1055 the method of steps S1025 to S1055 is repeated for all Address instances.

After all Address instances have been processed, at step S1060 a check is made for further replication entities. Here it is determined that a last replication entity, Order 730, remains.

At step S1020 replication entity Order 730 is selected. At step S1025 the instances associated with Order 730, i.e. instances of logical node Orders 530, are retrieved and the first instance is selected. At step S1030 it is determined that predecessor relationships exist: those with Customer 720 and Address 710. At step S1035, a check is made for the predecessor keys of the Customer predecessor instance and the Address predecessor instance, using respective links 1 and 4 of the modified source logical model of FIG. 8A. Assuming the keys are available, these are loaded at step S1040 together with state data for both predecessor instances. State model is then run at step S1045 with message “M3”. The state will then progress through the required states. At the “Replicate” state 1140 the appropriate relationships between target logical nodes Client 620, Address 610, and Orders 630 are created using the Customer 520 and Address 510 predecessor instances and the present Orders 530 instance. These relationships are created by the transformation engine 420 as part of the replication using the target API 425C. The state is saved at step S1050 and steps S1025 to S1055 are repeated for all Orders instances. At step S1060 it is determined that no replication entities remain in realised dependency graph 800 and the migration operation ends. The data shown in FIG. 5A has thus been successfully migrated from source 110 to the data structures of the target 120 shown in FIG. 5B.

A preferred embodiment of the present invention thus provides a computer-implemented method and system that enables error prevention, isolates errors, and prevents unnecessary attempts to migrate subsequent, related entities affected by their predecessor's error. This is accomplished by utilising metadata describing all of the associations between replication entities. The subsequent reduction in ‘cascading’ errors saves significant effort and hence cost in managing the errors that ‘fall out’ of the migration process. Maintaining the required replication or migration sequence for target 120, i.e. the “natural order”, ensures that the order in which different replication entities are loaded into the target 120 adheres to the needs of any target interface 125, maintaining all required associations throughout. The error prevention method and system is equally applicable to synchronisation of data, as this involves the same underlying replication operations.

The error prevention method and system is further improved by the optional use of a state model. A generic state model can be used for the replication of different replication entities and their associated instances, thus improving re-use of program components and reducing duplication of effort. A state model also allows greater flexibility, once a state for an instance is set, subsequent processing routines may make use of the state in their own time.

It is important to note that while the present invention has been described in a context of a fully functioning data processing system, for example data replication system 130, those of ordinary skill in the art will appreciate that the processes of the present invention are capable of being distributed in the form of a computer readable medium of instructions and a variety of forms and that the present invention applies equally regardless of a particular type of signal bearing media actually used to carry out distribution. Examples of computer readable media include recordable-type media such as floppy disks, a hard disk drive, RAM and CD-ROMs as well as transmission-type media such as digital and analogue communications links.

Generally, any of the functionality described in this text or illustrated in the figures can be implemented using computer-implemented processing, firmware (e.g., fixed logic circuitry), or a combination of these implementations. The terms “component”, “controller”, “engine” and “model” as used herein generally represents software, firmware, dedicated hardware or a combination of the above. For instance, in the case of a software implementation, the terms “component”, “controller”, “engine” and “model” may refer to program code that performs specified tasks when executed on a processing device or devices or configuration information that enables such tasks to be executed. The program code can be stored in one or more computer readable memory devices. The illustrated separation of components and functionality into distinct units may reflect an actual physical grouping and allocation of such software and/or hardware, or can correspond to a conceptual allocation of different tasks performed by a single software program and/or hardware unit.

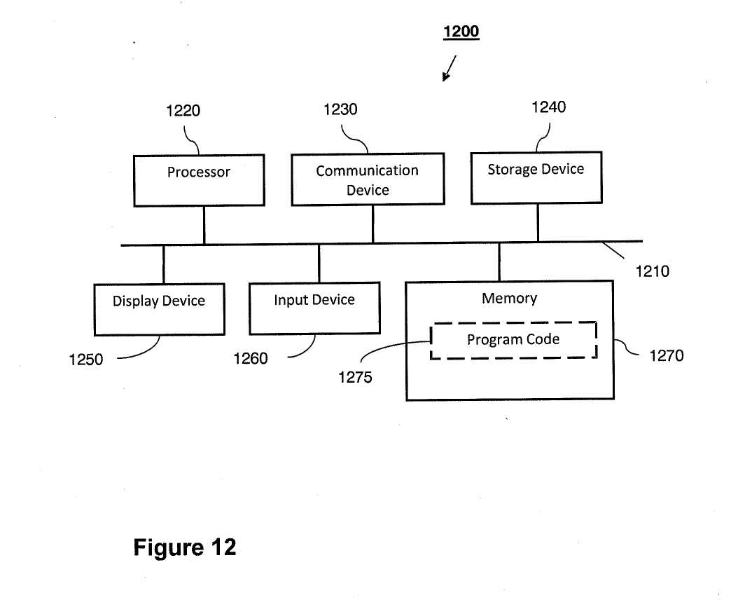

The data replication system 130 and/or the methods of the Figures may be implemented using the computer system 1200 of FIG. 12. Alternatively, the systems described herein may be implemented by one or more computer systems as shown in FIG. 12. FIG. 12 is provided as an example for the purposes of explaining the invention and one skilled in the art would be aware that the components of such a system may differ depending on requirements and user preference. The computer system of FIG. 12 comprises one or more processors 1220 connected to a system bus 1210. Also connected to the system bus 1210 is working memory 1270, which may comprise any random access or read only memory (RAM/ROM), display device 1250 and input device 1260. Display device 1250 is coupled GUI 150 to provide the user interface to the user. A user may then interact with the GUI 150 using input device 1260, which may comprise, amongst others known in the art, a mouse, pointer, keyboard or touch-screen. If a touch-screen is used display device 1250 and input device 1260 may comprise a single input/output device. The computer system may also optionally comprise one or more storage devices 1240 and communication device 1230. Storage devices 1240 may be any known local or remote storage system using any form of known storage media. In use, computer program code is loaded into working memory 1270 to be processed by the one or more processors 1220.

1. A method for replicating data between a source and a target, comprising:
defining a physical model of data stored within the source and a physical model of data stored within the target, each physical model representing a plurality of data structures;
defining a logical model of the data of the source and a logical model of the data of the target, each logical model comprising a plurality of nodes and being based on the data structures of the corresponding physical models;
defining a replication entity model comprising a plurality of replication entities, wherein each replication entity represents a corresponding logical node from each of the logical models;
defining one or more directed relationships between the replication entities defined in the replication entity model, the one or more directed relationships being specified by the data methods of the target; and
based on the order dictated by the one or more directed relationships, instructing the replication of each replication entity in turn,
wherein replication of a replication entity comprises replicating data within one or more selected data structures of the source in one or more selected data structures of the target, the selection being based on the mapping between the replication entity model and each of the logical models and the mapping between each of the logical models and the respective physical model.

2. The method of claim 1, wherein the step of instructing the replication of a replication entity comprises:
determining whether any predecessor replication entities exist;
if one or more predecessor replication entities exist, analysing each predecessor replication entity to confirm that data associated with said replication entity has been correctly replicated; and
if all predecessor replication entities have been correctly replicated, or if no predecessor replication entities exist, instructing the replication of the replication entity.

3. The method of claim 2, wherein the step of analysing each predecessor replication entity to confirm that data associated with said replication entity has been correctly replicated comprises evaluating a state model corresponding to the replication entity.

4. The method of claim 1, wherein:
the source and the target have different data formats;
the step of defining a replication entity model further comprises defining a transformation model to allow data to be transferred from the source to the target, the transformation model specifying how, for each replication entity, data of a first format from the source is to be mapped to data of a second format in the target; and
the replication of a replication entity comprises extracting data from the source associated with the replication entity using the logical and physical models for the source, transforming the data using the transformation model, and loading the data into the target using the logical and physical models for the target.

5. The method of claim 4, wherein the step of defining a transformation model comprises specifying an interface that accepts zero or more predecessor keys and the step of replicating a replication entity comprises passing predecessor keys associated with any predecessor replication entities deemed to exist to the transformation model.

6. The method of claim 1, wherein the directed relationships are represented using a dependency graph.

7. The method of claim 1, wherein replication of a replication entity comprises identifying the logical node of the source that maps to the replication entity and replicating one or more instances of said logical node using the mapping between said node and the respective data structures of the physical model.

8. The method of claim 1, wherein the method is performed as part of a data migration process, the source and target representing respectively the source and target of the migration.

9. The method of claim 1, wherein the method is performed as part of a data synchronisation process, the target being synchronised to the source during the process, wherein the source is the origin for the synchronisation and the target is the destination.

10. The method of claim 1, wherein the method is repeated with the source as the target and the target as the source to provide bidirectional synchronisation, wherein the target is the origin for the synchronisation and the source is the destination in one direction and the source is the origin for the synchronisation and the target is the destination in another direction.

11. A system for data replication between a source and a target, comprising:
a transformation engine connectable to the source and the target, the transformation engine comprising:
a physical model of data stored within the source and a physical model of data stored within the target, each physical model representing a plurality of data structures; and
a logical model of the data of the source and a logical model of the data of the target, each logical model comprising a plurality of nodes and being based on the data structures of the corresponding physical models; and
a replication engine connectable to the transformation engine, comprising:
a replication entity model comprising a plurality of replication entities, wherein each entity represents a corresponding logical node from each of the logical models; and
a directed relationship model comprising one or more directed relationships between the replication entities defined in the replication entity model, the one or more directed relationships being specified by the data methods of the target;
wherein, in use, the replication engine is adapted to instruct the transformation engine to replicate each replication entity in turn based on the order dictated by the one or more directed relationships in the directed relationship model, and
wherein replication of a replication entity by the transformation engine comprises replicating data within one or more selected data structures of the source in one or more selected data structures of the target, the selection being based on the mapping between the replication entity model and each of the logical models and the mapping between each of the logical models and the respective physical model.

12. The system of claim 11, wherein the replication engine is adapted to process the directed relationship model and for each replication entity referenced in turn:
determine whether any predecessor replication entities exist;
if one or more predecessor replication entities exist, analyse each predecessor replication entity to confirm that data associated with said replication entity has been correctly replicated; and
if all predecessor replication entities have been correctly replicated, or if no predecessor replication entities exist, instruct the replication of the replication entity.

13. The system of claim 11, wherein the replication engine further comprises a state model for each replication entity.

14. The system of claim 11, wherein the transformation engine further comprises:
a transformation model to allow data to be transferred from the source to the target, the transformation model specifying how, for each replication entity, data of a first format from the source is to be mapped to data of a second format in the target; and
the transformation engine being adapted to replicate a replication entity by extracting data from the source associated with the replication entity using the logical and physical models for the source, transforming the data using the transformation model, and loading the data into the target using the logical and physical models for the target.

15. The system of claim 14, wherein the transformation model comprises an interface that accepts zero or more predecessor keys, the replication engine being adapted to pass the predecessor keys associated with any predecessor replication entities deemed to exist to the transformation engine using the interface.

16. A method for replicating data between a source and a target, comprising:
defining a replication entity model comprising a plurality of replication entities, wherein each replication entity represents data stored in the source and data stored in the target;
generating a dependency graph comprising one or more directed relationships between the replication entities defined in the replication entity model, the one or more directed relationships being specified by the data methods of the target; and
based on the order dictated by the one or more directed relationships, instructing the replication of each replication entity in turn,
wherein replication of a replication entity comprises replicating data within one or more selected data structures of the source in one or more selected data structures of the target.

17. The method of claim 16, wherein the order dictated by the one or more directed relationships is inferred from a breadth-first walk of the dependency graph.

18. A system for data replication between a source and a target, comprising:
a transformation engine connectable to the source and the target; and
a replication engine connectable to the transformation engine, comprising:
a replication entity model comprising a plurality of replication entities, wherein each entity represents data stored in the source and data stored in the target; and
a dependency graph comprising one or more directed relationships between the replication entities defined in the replication entity model, the one or more directed relationships being specified by the data methods of the target;
wherein, in use, the replication engine is adapted to instruct the transformation engine to replicate each replication entity in turn based on the order dictated by the one or more directed relationships in the dependency graph, and
wherein replication of a replication entity by the transformation engine comprises replicating data within one or more selected data structures of the source in one or more selected data structures of the target.

19. The system of claim 18, further comprising:
a breadth-first walk algorithm configured to process the dependency graph and output an ordered list dictating the order in which the replication engine is adapted to instruct the transformation engine to replicate each replication entity.

20. A method for replicating data between a source and a target, comprising:
defining a replication entity model comprising a plurality of replication entities, wherein each replication entity represents data stored in the source and data stored in the target;
generating a state model for one or more instances associated with each replication entity defined in the replication entity model; and
using the state model, instructing the replication of the one or more instances associated with each replication entity in turn,
wherein replication of an instance of a replication entity comprises replicating data within one or more selected data structures of the source in one or more selected data structures of the target.

21. The method of claim 20, wherein replication of an instance occurs when the instance is in a replicate state, the state model enabling progression to a replicate state if all predecessor instances are in a state indicating successful replication.

22. A system for data replication between a source and a target, comprising:
a transformation engine connectable to the source and the target; and
a replication engine connectable to the transformation engine, comprising:
a replication entity model comprising a plurality of replication entities, wherein each entity represents data stored in the source and data stored in the target; and
a state model for one or more instances associated with each replication entity defined in the replication entity model;
wherein, in use, the replication engine is adapted to use the state model to instruct the transformation engine to replicate the one or more instances associated with each replication entity in turn, and
wherein replication of an instance of a replication entity by the transformation engine comprises replicating data within one or more selected data structures of the source in one or more selected data structures of the target.

23. The method of claim 22, wherein the state model comprises a replicate state and a successfully replicated state, the replication engine being configured to replicate an instance when the instance is in the replicate state, the state model enabling progression to the replicate state if all predecessor instances are in the successfully replicated state.
